(19) United States
(12) Patent Application Publication
(10) Pub. No.: US 2016/0238207 A1
(43) Pub. Date: Aug. 18, 2016

(54) VEHICLE LAMP MODULE AND LENS

(71) Applicant: Coretronic Corporation, Hsin-Chu (TW)

(72) Inventors: Chi-Tang Hsieh, Hsin-Chu (TW); Han-Wen Tsai, Hsin-Chu (TW); Kuo-Sheng Huang, Hsin-Chu (TW)

(21) Appl. No.: 14/844,014

(22) Filed: Sep. 3, 2015

(30) Foreign Application Priority Data
Feb. 12, 2015 (TW) 104104722

(51) Int. Cl. F21S 8/10

(52) U.S. Cl. CPC F21S 48/1283

(57) ABSTRACT

A lens includes a light input surface and a light output surface. The light output surface is opposite to the light input surface. A central region of the light output surface has a plurality of cylindrical surface microstructures. A depth of the cylindrical surface microstructures in a direction parallel to an optical axis of the lens is within a range from 0.02 millimeter to 0.2 millimeter. A vehicle lamp module is also provided.

### CROSS-REFERENCE TO RELATED APPLICATION

This application claims the priority benefit of Taiwan application serial no. 104104722, filed on Feb. 12, 2015. The entirety of the above-mentioned patent application is hereby incorporated by reference herein and made a part of this specification.

### FIELD OF THE INVENTION

The invention relates to a light source module and an optical device; more particularly, the invention relates to a vehicle lamp module and a lens.

### DESCRIPTION OF RELATED ART

The lens in most of the vehicle lamps, for example, the vehicle lamp using a light emitting diode (LED) as the light source, is characterized by one single lens. According to the optical principle, the thickness ratio of the lens determines the level of dispersion.

The color shift issue is normally resolved by using a doublet lens consisting of a positive lens and a negative lens which are respectively made of materials with different dispersion characteristics and are adhered to each other, and thereby the dispersion issue can be resolved. However, the use of the doublet lens may reduce the optical efficiency, increase weight and the manufacturing costs, and increase the back focal length which may have influence on the volume of the entire system. Besides, the adhesive used to adhere the two lenses to each other may have an issue on reliability. For example, the adhesive may be degraded if it is placed in a high-temperature environment for a long period of time. Moreover, it is difficult to find two compatible plastic materials for mass production by using an injection molding process.

China Patent Application Publication No. 103629625A discloses a light guiding unit featuring microstructures. China Utility Patent No. 201017045Y discloses an aspheric lens with the design of one single lens. U.S. Pat. No. 6,352,359B1 discloses a lens cap or a cap located on the casing.

The information disclosed in this “Description of Related Art” section is only for enhancement understanding of the background of the invention and therefore it may contain information that does not form the prior art that is already known to a person of ordinary skill in the art. Furthermore, the information disclosed in this “Description of Related Art” section does not mean that one or more problems to be solved by one or more embodiments of the invention were acknowledged by a person of ordinary skill in the art.

### SUMMARY OF THE INVENTION

The invention is directed to a vehicle lamp module capable of effectively resolving the issue of dispersion.

The invention is also directed to a lens capable of effectively resolving the issue of dispersion.

Other objectives and advantages of the invention can be further illustrated by the technical features broadly embodied and described as follows.

To achieve one, a part, or all of the above advantages or other advantages, an embodiment of the invention provides a vehicle lamp module and a lens having microstructures. In an embodiment of the invention, a vehicle lamp module including a light emitting device and a lens is provided. The light emitting device is capable of emitting light, and the lens has a light input surface and a light output surface opposite to each other. At least a portion of the light from the light emitting device sequentially passes through the light input surface and the light output surface. A central region of the light output surface has a plurality of cylindrical surface microstructures. A depth of the cylindrical surface microstructures in a direction parallel to an optical axis of the lens is within a range from 0.02 millimeter to 0.2 millimeter.

To achieve one, a part, or all of the above advantages or other advantages, an embodiment of the invention provides a lens that includes a light input surface and a light output surface. The light output surface is opposite to the light input surface. A central region of the light output surface has a plurality of cylindrical surface microstructures. A depth of the cylindrical surface microstructures in a direction parallel to an optical axis of the lens is within a range from 0.02 millimeter to 0.2 millimeter.

According to an embodiment of the invention, the central region substantially coincides with an orthogonal projection of the light input surface along the optical axis on the light output surface.

According to an embodiment of the invention, the light output surface is a convex curved surface.

According to an embodiment of the invention, the cylindrical surface microstructures are convex cylindrical surfaces or concave cylindrical surfaces.

According to an embodiment of the invention, the cylindrical surface microstructures are arranged along a first direction, each of the cylindrical surface microstructures extends along a second direction, and curvature radii of the cylindrical surface microstructures gradually decrease from a central portion of the central region to two end portions of the central region along a direction substantially parallel to the first direction.

According to an embodiment of the invention, the cylindrical surface microstructures are arranged along a first direction, each of the cylindrical surface microstructures extends along a second direction, and curvature radii of the cylindrical surface microstructures gradually increase from a central portion of the central region to two end portions of the central region along a direction substantially parallel to the first direction.

According to an embodiment of the invention, the cylindrical surface microstructures are arranged along a first direction, each of the cylindrical surface microstructures extends along a second direction, and a pitch of the cylindrical surface microstructures along the first direction is within a range from 0.1 millimeter to 3 millimeters.

According to an embodiment of the invention, the cylindrical surface microstructures are arranged along a first direction, each of the cylindrical surface microstructures extends along a second direction, and the cylindrical surface microstructures closely adjoin each other along the first direction.

According to an embodiment of the invention, the cylindrical surface microstructures are arranged along a first direction, each of the cylindrical surface microstructures extends along a second direction, and the cylindrical surface microstructures are spaced from each other along the first direction.

According to an embodiment of the invention, the lens further includes an inner surrounding surface and an outer connection surface. The inner surrounding surface is connected to the light input surface, and the inner surrounding surface and the light input surface constitute a recess containing the light emitting device. The outer connection surface connects the inner surrounding surface and the light output surface.

In the embodiments of the vehicle lamp module and the lens of the present invention, the central region of the light output surface has the cylindrical surface microstructures, and the depth of the cylindrical surface microstructures in the direction parallel to the optical axis of the lens is within a range from 0.02 millimeter to 0.2 millimeter. Therefore, the embodiments can achieve favorable light diffusion effects and further effectively resolve the issue of dispersion resulting from the refraction by the lens.

Other features and advantages of the invention will be further understood from the further technological features disclosed by the embodiments of the invention wherein there are shown and described embodiments of this invention, simply by way of illustration of modes suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic front view illustrating a vehicle lamp module according to an embodiment of the invention.

FIG. 1B is a schematic side view illustrating the vehicle lamp module depicted in FIG. 1A.

FIG. 1C is a schematic cross-sectional view illustrating the vehicle lamp module depicted in FIG. 1A along a line I-I.

FIG. 1D is a schematic three-dimensional view illustrating the cylindrical surface microstructures depicted in FIG. 1A.

FIG. 2 is a schematic cross-sectional view illustrating a portion of a lens according to another embodiment of the invention.

FIG. 3 is a schematic cross-sectional view illustrating a portion of a lens according to still another embodiment of the invention.

FIG. 4 is a schematic cross-sectional view illustrating a portion of a lens according to still another embodiment of the invention.

FIG. 5 is a schematic cross-sectional view illustrating a portion of a lens according to still another embodiment of the invention.

### DETAILED DESCRIPTION OF DISCLOSED EMBODIMENTS

In the following detailed description of the embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting.

On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

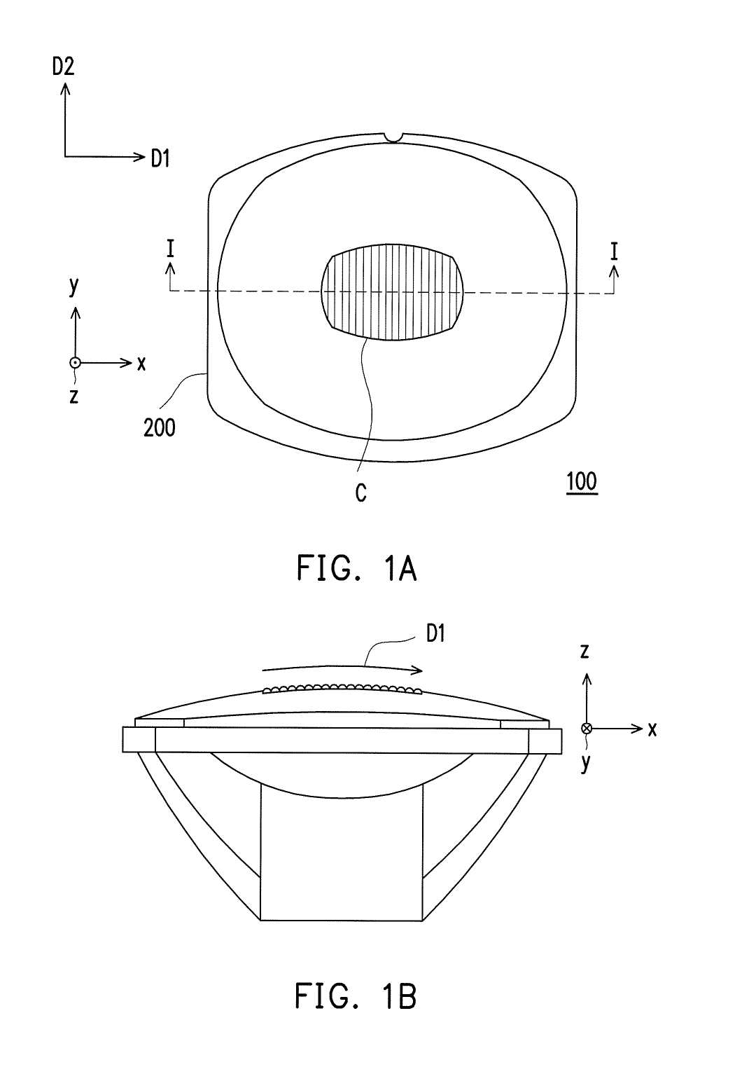

FIG. 1A is a schematic front view illustrating a vehicle lamp module according to an embodiment of the invention. FIG. 1B is a schematic side view illustrating the vehicle lamp module depicted in FIG. 1A. FIG. 1C is a schematic cross-sectional view illustrating the vehicle lamp module depicted in FIG. 1A along a line I-I. FIG. 1D is a schematic three-dimensional view illustrating the cylindrical surface microstructures depicted in FIG. 1A. With reference to FIG. 1A to FIG. 1D, the vehicle lamp module 100 provided in the present embodiment includes a light emitting device 110 and a lens 200. The light emitting device 110 serves to emit light 112. According to the present embodiment, the light emitting device 110 is, for instance, a light emitting diode (LED). However, in other embodiments, the light emitting device 110 may also be a mercury light bulb, a halogen light bulb, an incandescent light bulb, a laser diode, a solid state light source, or any other appropriate light emitting device.

As exemplarily indicated in FIG. 1C, the lens 200 has a light input surface (i.e., light incident surface) 210 and a light output surface 220 opposite to each other. At least a portion of the light 112 from the light emitting device 110 sequentially passes through the light input surface 210 and the light output surface 220. As shown in FIG. 1A and FIG. 1C, a central region C of the light output surface 220 has a plurality of cylindrical surface microstructures 222. The cylindrical surface microstructures 222, for example, are the lenticular lenses. A depth D of the cylindrical surface microstructures 222 in a direction parallel to an optical axis A of the lens 200 is within a range from 0.02 millimeter to 0.2 millimeter.

According to the present embodiment, the lens 200 further includes an inner surrounding surface 230 and an outer connection surface 240. The inner surrounding surface 230 is connected to the light input surface 210, and the inner surrounding surface 230 and the light input surface 210 constitute a recess 205 containing the light emitting device 110. As exemplarily indicated in FIG. 1C, the top surface of the recess 205 is the light input surface 210, and the lateral surface of the recess 205 is the inner surrounding surface 230. The outer connection surface 240 connects the inner surrounding surface 230 and the light output surface 220. In the present embodiment, a portion 112a of the light 112 emitted from the light emitting device 110 sequentially passes through the light input surface 210 and the cylindrical surface microstructures 222, and the cylindrical surface microstructures 222 are capable of diffusing the portion 112a of the light 112. In addition, a portion 112b of the light 112 emitted from the light emitting device 110 sequentially passes through the light input surface 210 and the region of the light output surfaces 220 other than the central region C, i.e., the portion 112b of the light 112 does not pass through the cylindrical surface microstructures 222, and the portion 112b is refracted by the light input surface 210 and the light output surface 220. A portion 112c of the light 112 emitted from the light emitting device 110 sequentially passes through the inner surrounding surface 230, is reflected (e.g., totally internally reflected) by the outer connection surface 240, and passes through the region of the light output surface 220 other than the central region C. Hence, the portion 112c of the light 112 is subject to the refraction by the inner surrounding surface 230 and the light output surface 220 and the reflection by the outer connection surface 240. When the regions illuminated by the portions 112a, 112b, and 112c of light are added up, the diffusion of the portion 112a of the light 112 by the cylindrical surface microstructures 222 can effectively lower the level of dispersion in the whole illuminated region. That is, color breakup caused by dispersion cannot be easily observed on the edges of the illuminated region. As exemplarily indicated in FIG. 1C, in one embodiment, the light input surface faces the emitting side (e.g., emitting surface) of the light emitting device 110. The light output surface 220 having the cylindrical surface microstructures 222 and the light emitting device 110 are located at the opposite sides of the light input surface 210. When the portion 112c of light entering the inner surrounding surface 230, the inner surrounding surface 230 serves as the second light input surface, while the light input surface 210 facing the emitting side of the light emitting device 110 serves as the first light input surface.

According to the present embodiment, in the vehicle lamp module 100 and the lens 200, the central region C of the light output surface 220 has the cylindrical surface microstructures 222, and the depth D of the cylindrical surface microstructures 222 in the direction parallel to the optical axis A of the lens 200 is within a range from 0.02 millimeter to 0.2 millimeter so that the embodiment can achieve favorable light diffusion effects and further effectively resolve the issue of dispersion resulting from the refraction by the lens 200. In the present embodiment, the cylindrical surface microstructures 222 are located on the central region C rather than on the entire light output surface 220. Therefore, the light loss of the vehicle lamp module 100 at the center of the illuminated region (i.e., the location on or near the optical axis) with the maximum brightness can be reduced. Additionally, the depth D of the cylindrical surface microstructures 222 is within the range from 0.02 millimeter to 0.2 millimeter and is not excessively large, the light loss at the center of the illuminated region with the maximum brightness can be effectively reduced as well. Moreover, the depth D of the cylindrical surface microstructures 222 is not excessively small, therefore, the difficulties of forming the cylindrical surface microstructures 222 by performing the injection molding process can be prevented to better extent.

According to the present embodiment, the cylindrical surface microstructures 222 are arranged along a first direction D1, and each of the cylindrical surface microstructures 222 extends along a second direction D2. For instance, the first direction D1 is substantially parallel to the direction x, and the second direction D2 is substantially parallel to the direction y as observed in the front view of the lens 100 from the side of the output surface as exemplarily shown in FIG. 1A. As exemplarily indicated in FIG. 1A, in one embodiment, the second direction D2 is substantially parallel to the widthwise of the lens 200, and the first direction D1 is perpendicular to the second direction D2. However, in the side view as shown in FIG. 1B, for instance, the first direction D1 may conform to the shape (e.g., bending) of the light output surface 220; similarly, the second direction D2 may conform to the shape (e.g., bending) of the light output surface 220. In other words, in one embodiment, the cylindrical surface microstructures 222 can be arranged in an arc shape along the first direction D1, and each of the cylindrical surface microstructures 222 can extend in an arc shape along the second direction D2. According to the present embodiment, the cylindrical surface microstructures 222 closely adjoin each other along the first direction D1. Here, the directions x, y, and z are perpendicular to one another, and the direction z is substantially parallel to the optical axis A.

In the present embodiment, the light output surface 220 and the light input surface 210 can both be curved surfaces, e.g., convex curved surfaces, so as to condense light or diffuse light. In addition, according to the present embodiment, the cylindrical surface microstructures 222 may be convex cylindrical surfaces. However, in another embodiment, the cylindrical surface microstructures 222 may be concave cylindrical surfaces. In an embodiment of the invention, a pitch P of the cylindrical surface microstructures 222 along the first direction D1 is within a range from 0.1 millimeter to 3 millimeters. In the present embodiment, the curvature radius (i.e., the curvature radius shown in the cross-sectional view of FIG. 1C) of each of the cylindrical surface microstructures 222 are substantially the same. However, in another embodiment of the invention, the curvature radii of the cylindrical surface microstructures 222 may be completely different; alternatively, some of the curvature radii are the same, while some of the curvature radii are different.

In the present embodiment, an orthogonal projection of the light input surface 220 along the optical axis A on the light output surface 220 (e.g., the orthogonal projection on the light output surface 220 within a range defined by two dotted lines on two sides of the optical axis A, as exemplarily shown in FIG. 1C) substantially coincides with the central region C (e.g., the region of the light output surface 220 within the range defined by the two dotted lines).

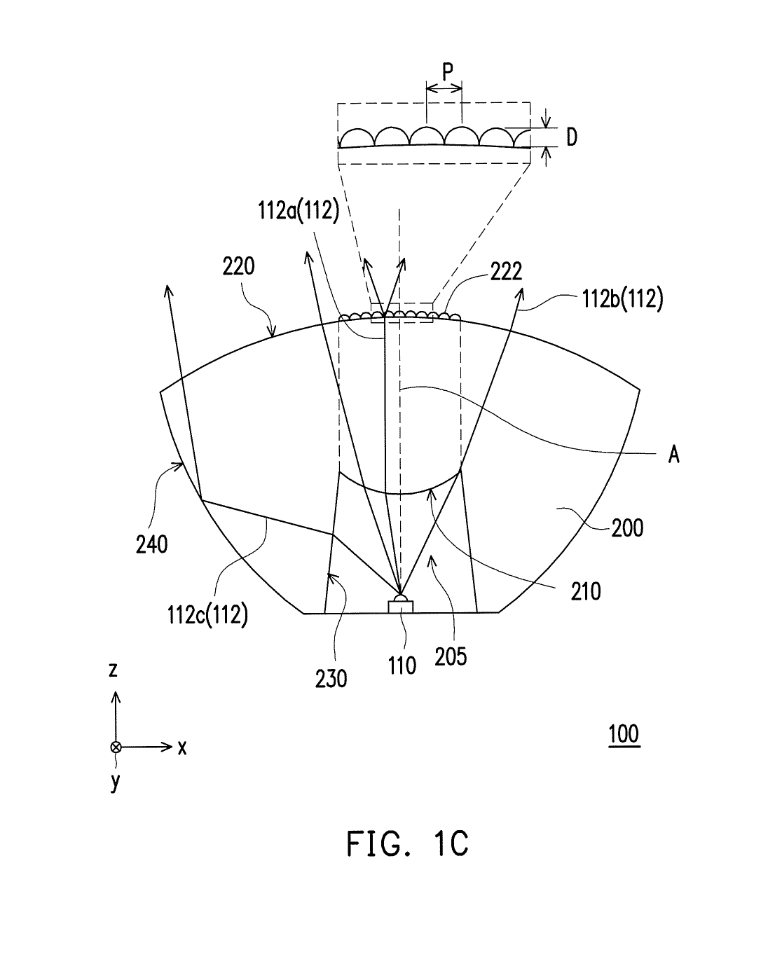

FIG. 2 is a schematic cross-sectional view illustrating a portion of a lens according to still another embodiment of the invention. With reference to FIG. 2, the lens 200a provided in the present embodiment is similar to the lens 200 depicted in FIG. 1C, and the difference between these two lenses 200a and 200 is described below. In the lens 200a according to the present embodiment, the cylindrical surface microstructures 222a of the light output surface 220a are concave cylindrical surfaces.

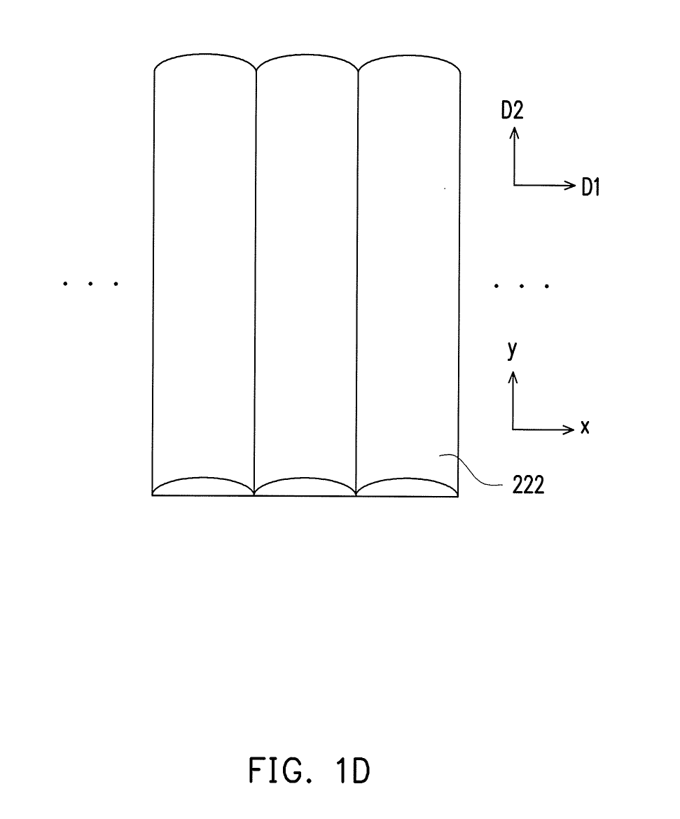

FIG. 3 is a schematic cross-sectional view illustrating a portion of a lens according to still another embodiment of the invention. With reference to FIG. 3, the lens 200b provided in the present embodiment is similar to the lens 200 depicted in FIG. 1C, and the difference between these two lenses 200b and 200 is described below. In the lens 200b according to the present embodiment, the curvature radii R (e.g., the curvature radii shown in the cross-sectional view as shown in FIG. 3) of the cylindrical surface microstructures 222b of the light output surface 220b gradually decreases from a central portion of the central region C to two end portions of the central region C along a direction substantially parallel to the first direction D1. The change of the curvature radii R of the cylindrical surface microstructures in gradual 222b is facilitate the alleviation of the dispersion and the increase in the large-angle illumination brightness.

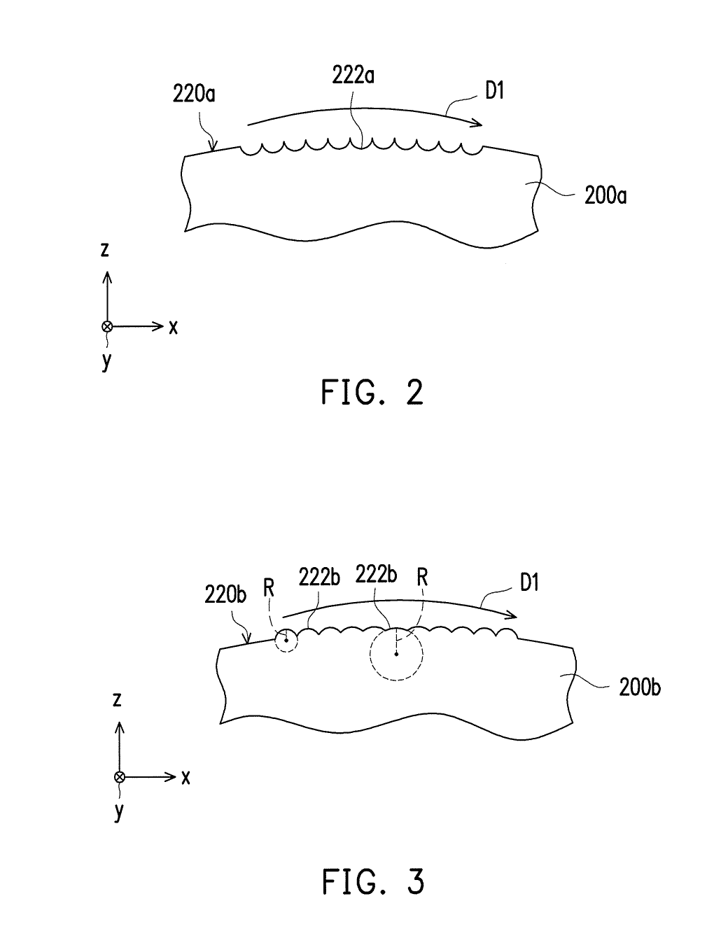

FIG. 4 is a schematic cross-sectional view illustrating a portion of a lens according to still another embodiment of the invention. With reference to FIG. 4, the lens 200c provided in the present embodiment is similar to the lens 200 depicted in FIG. 1C, and the difference between these two lenses 200c and 200 is described below. In the lens 200c according to the present embodiment, the curvature radii R (e.g., the curvature radii shown in the cross-sectional view as shown in FIG. 4) of the cylindrical surface microstructures 222c of the light output surface 220c gradually increases from a central portion of the central region C to two end portions of the central region C along a direction substantially parallel to the first direction D1.

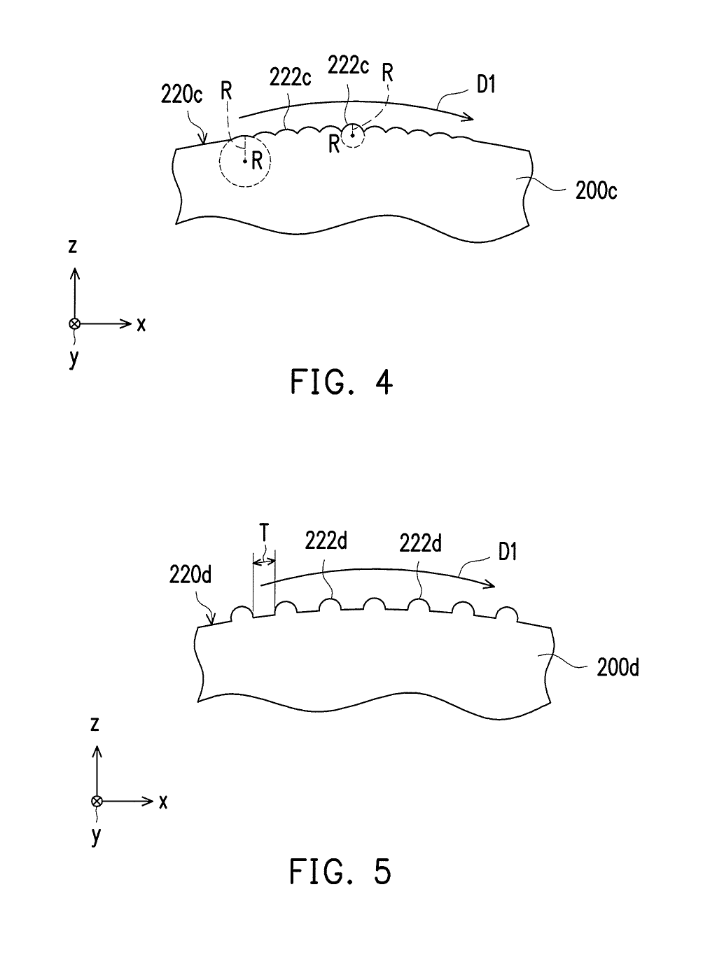

FIG. 5 is a schematic cross-sectional view illustrating a portion of a lens according to still another embodiment of the invention. With reference to FIG. 5, the lens 200d provided in the present embodiment is similar to the lens 200 depicted in FIG. 1C, and the difference between these two lenses 200d and 200 is described below. In the lens 200d provided in the present embodiment, the cylindrical surface microstructures 222d of the light output surface 220d are spaced from each other along the first direction D1 by the same interval T, for instance. Such a design may further reduce the light loss at the center of the illuminated region, and the issue of dispersion can be resolved to a certain degree.

Table 1 provided below lists a vehicle lamp module having no cylindrical surface microstructure according to an embodiment, the vehicle lamp module 100 shown in FIG. 1C, and the vehicle lamp module having the lens 200b depicted in FIG. 3, and also indicates the simulation results of brightness at different test points according to Transport Regulation No. 112 stipulated by the United Nations Economic Commission for Europe (ECE).

TABLE 1

| | | | | Loss ratio of brightness of |
|---|---|---|---|---|
| | vehicle lamp | | vehicle lamp | the vehicle lamp module having |
| | module having | vehicle lamp | module having | the lens depicted in FIG. 3 to |
| | no cylindrical | module 100 | the lens | brightness of vehicle lamp |
| | surface | shown | depicted | module having no cylindrical |
| ECE R112 | microstructure | in FIG. 1C | in FIG. 3 | surface microstructure |
| Imax (maximum | 47,376 | 47,491 | 45,855 | −3.21% |
| brightness) | | | | |
| H-5L (5 degrees | 11,465 | 9,988 | 10,100 | −11.91% |
| left from the | | | | |
| center) | | | | |
| H-2.5L(2.5 | 31,014 | 29,600 | 29,677 | −4.31% |
| degrees left | | | | |
| from the center) | | | | |
| H-2.5R(2.5 | 29,963 | 29,659 | 28,770 | −3.98% |
| degrees right | | | | |
| from the center) | | | | |
| H-5R(5 degrees | 10,526 | 9,863 | 9,543 | −9.34% |
| right from the | | | | |
| center) | | | | |

The “center” shown in Table 1 indicates the center of the illuminated region, i.e., where the optical axis A is located. “2.5 degrees right from the center” indicates a test point deviated from the optical axis A by 2.5 degrees along the direction +x, and the other test points can be deduced therefrom by analogy. It can be learned from Table 1 that the dispersion can be effectively alleviated while the brightness is not reduced significantly (especially the brightness at the center of the illuminated region is not reduced significantly) according to an embodiment of the invention. Besides, the lenses 200, 200a, 200b, 200c, and 200d can be made of single one material, and thus the conventional issue of using the doublet lens can be prevented. Further, according to Table 1, the lenses 200, 200a, 200b, 200c, and 200d provided in the embodiments of the invention are applicable to high beam lamps for vehicles and are compliant with relevant laws and regulations.

In the embodiments of the vehicle lamp module and the lens of the present invention, the central region of the light output surface has the cylindrical surface microstructures, and the depth of the cylindrical surface microstructures in the direction parallel to the optical axis of the lens is within a range from 0.02 millimeter to 0.2 millimeter. Therefore, the embodiments can achieve favorable light diffusion effects and further effectively resolve the issue of dispersion resulting from the refraction by the lens.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A vehicle lamp module comprising:
a lens having a light input surface and a light output surface opposite to each other; and
a light emitting device capable of emitting at least a portion of light to sequentially passing through the light input surface and the light output surface, wherein a central region of the light output surface has a plurality of cylindrical surface microstructures, and a depth of the cylindrical surface microstructures in a direction parallel to an optical axis of the lens is within a range from 0.02 millimeter to 0.2 millimeter.

2. The vehicle lamp module of claim 1, wherein the central region substantially coincides with an orthogonal projection of the light input surface along the optical axis on the light output surface.

3. The vehicle lamp module of claim 1, wherein the light output surface is a convex curved surface.

4. The vehicle lamp module of claim 1, wherein the cylindrical surface microstructures are convex cylindrical surfaces or concave cylindrical surfaces.

5. The vehicle lamp module of claim 1, wherein the cylindrical surface microstructures are arranged along a first direction, each of the cylindrical surface microstructures extends along a second direction, and curvature radii of the cylindrical surface microstructures gradually decrease from a central portion of the central region to two end portions of the central region along a direction substantially parallel to the first direction.

6. The vehicle lamp module of claim 1, wherein the cylindrical surface microstructures are arranged along a first direction, each of the cylindrical surface microstructures extends along a second direction, and curvature radii of the cylindrical surface microstructures gradually increase from a central portion of the central region to two end portions of the central region along a direction substantially parallel to the first direction.

7. The vehicle lamp module of claim 1, wherein the cylindrical surface microstructures are arranged along a first direction, each of the cylindrical surface microstructures extends along a second direction, and a pitch of the cylindrical surface microstructures along the first direction is within a range from 0.1 millimeter to 3 millimeters.

8. The vehicle lamp module of claim 1, wherein the cylindrical surface microstructures are arranged along a first direction, each of the cylindrical surface microstructures extends along a second direction, and the cylindrical surface microstructures closely adjoin each other along the first direction.

9. The vehicle lamp module of claim 1, wherein the cylindrical surface microstructures are arranged along a first direction, each of the cylindrical surface microstructures extends along a second direction, and the cylindrical surface microstructures are spaced from each other along the first direction.

10. The vehicle lamp module of claim 1, wherein the lens further comprises:
an inner surrounding surface connected to the light input surface, the inner surrounding surface and the light input surface constituting a recess containing the light emitting device; and
an outer connection surface connecting the inner surrounding surface and the light output surface.

11. A lens suitable for a vehicle lamp, the lens comprising:
a light input surface; and
a light output surface opposite to the light input surface, a central region of the light output surface having a plurality of cylindrical surface microstructures, wherein a depth of the cylindrical surface microstructures in a direction parallel to an optical axis of the lens is within a range from 0.02 millimeter to 0.2 millimeter.

12. The lens of claim 11, wherein the central region substantially coincides with an orthogonal projection of the light input surface along the optical axis on the light output surface.

13. The lens of claim 11, wherein the light output surface is a convex curved surface.

14. The lens of claim 11, wherein the cylindrical surface microstructures are convex cylindrical surfaces or concave cylindrical surfaces.

15. The lens of claim 11, wherein the cylindrical surface microstructures are arranged along a first direction, each of the cylindrical surface microstructures extends along a second direction, and curvature radii of the cylindrical surface microstructures gradually decrease from a central portion of the central region to two end portions of the central region along a direction substantially parallel to the first direction.

16. The lens of claim 11, wherein the cylindrical surface microstructures are arranged along a first direction, each of the cylindrical surface microstructures extends along a second direction, and curvature radii of the cylindrical surface microstructures gradually increase from a central portion of the central region to two end portions of the central region along a direction substantially parallel to the first direction.

17. The lens of claim 11, wherein the cylindrical surface microstructures are arranged along a first direction, each of the cylindrical surface microstructures extends along a second direction, and a pitch of the cylindrical surface microstructures along the first direction is within a range from 0.1 millimeter to 3 millimeters.

18. The lens of claim 11, wherein the cylindrical surface microstructures are arranged along a first direction, each of the cylindrical surface microstructures extends along a second direction, and the cylindrical surface microstructures closely adjoin each other along the first direction.

19. The lens of claim 11, wherein the cylindrical surface microstructures are arranged along a first direction, each of the cylindrical surface microstructures extends along a second direction, and the cylindrical surface microstructures are spaced from each other along the first direction.

20. The lens of claim 11, further comprising:
an inner surrounding surface connected to the light input surface, the inner surrounding surface and the light input surface constituting a recess; and
an outer connection surface connecting the inner surrounding surface and the light output surface.
